(19) United States
(12) Patent Application Publication
(10) Pub. No.: US 2011/0080635 A1
(43) Pub. Date: Apr. 7, 2011

(54) IMAGE DISPLAY DEVICE AND IMAGE DISPLAY METHOD

(76) Inventor: Katsuyuki Takeuchi, Tokyo (JP)

(21) Appl. No.: 12/736,974

(22) PCT Filed: Jun. 13, 2008
(86) PCT No.: PCT/JP2008/060850

§ 371 Date: Nov. 29, 2010

(51) Int. Cl. G02B 27/24; G02B 27/10

(52) U.S. Cl. 359/350; 359/634; 359/464

(57) ABSTRACT

A image display device of the present invention forms and displays an image by light emitted from a light source. The image display device includes a wavelength selection means (2) arranged on the light path of light emitted from the light source and that, as the reflected light of this light, reflects light belonging to a first wavelength range and light belonging to a second wavelength range that differs from the first wavelength range at a predetermined period.

### TECHNICAL FIELD

The present invention relates to an image display device and an image display method that enable projection of a stereoscopic image.

### BACKGROUND ART

With the digitization of image data in recent years, image display devices that can project stereoscopic images are becoming widespread. An image display device enables the projection of a stereoscopic image by guiding, of two images that take binocular parallax into consideration, one image (the image for the left eye) to the left eye and the other image (the image for the right eye) to the right eye.

Methods of projecting such stereoscopic images include methods that employ polarizing filters (for example, refer to Patent Document 1 and Patent Document 2 shown hereinbelow) and methods that employ a wavelength-dividing filter (for example, refer to Patent Document 3 shown hereinbelow).

In the above-mentioned methods that employ polarizing filters, light that is emitted from a light source is divided into light of two orthogonal polarized beams. The left-eye image is formed by one polarized light beam, and the right-eye image is formed by the other polarized light beam.

The image display device described in Patent Document 1 or Patent Document 2 includes a wavelength selection filter that selects and transmits light for each wavelength to form an image that corresponds to full color.

In an image display device of the form that employs a polarizing filter as described above, the polarized state of the light must be maintained in order to reflect a polarized light beam on a screen to display an image. To this end, a silver screen is chiefly used as the screen. As a result, construction of the equipment for projecting a stereoscopic image necessitates the exchange of screens and raises the problem of increased cost.

In the method described above that employs a wavelength-dividing filter, on the other hand, light that is emitted from a light source passes through a wavelength-dividing filter and is divided into light belonging to two different wavelength ranges. The left-eye image is then formed by light belonging to one wavelength range and the right-eye image is formed by light belong to the other wavelength range.

In the method that employs this wavelength-dividing filter, no attention needs to be paid to changes in the plane of the polarization of light, and a stereoscopic image can therefore be projected on a screen that is installed for projecting a two-dimensional image. Accordingly, an image display device of the type that employs a wavelength-dividing filter has an economic advantage.

The image display device described in, for example, Patent Document 3 includes a wavelength selection filter. The wavelength selection filter selects and transmits the illumination light from a light source by time division into a first band and a second band for each red band, green band and blue band.

In an image display device that includes this type of wavelength-dividing filter, however, the brightness of the image is greatly decreased compared to the display of a normal two-dimensional image. Brightness is improved by using a high-power light source, but this solution raises the problem of increased power consumption.

An improvement of light utilization efficiency is therefore desired in an image display device that employs a wavelength-dividing filter.

### Patent Document 1: JP2006-058339A

### Patent Document 2: JP2007-017536A

### Patent Document 3: JP2007-328122A

### SUMMARY

It is an object of the present invention to provide an image display device and image display method that provide a solution to any one of the problems described above.

One aspect of the present invention relates to an image display device that forms and displays an image from light emitted from a light source. This image display device includes wavelength selection means that is arranged on the light path of light that is emitted from a light source and that, as the reflected light of this light, reflects light belonging to a first wavelength range and light belonging to a second wavelength range that differs from the first wavelength range at a predetermined period.

Another aspect of this invention relates to an image display method for forming and displaying an image by light emitted from a light source. The image display method includes steps of emitting light from the light source and reflecting, as reflected light, light belonging to a first wavelength range and light belonging to a second wavelength range that differs from the first wavelength range at a predetermined period.

### BRIEF DESCRIPTION OF THE DRAWINGS

FIG. 1 is a schematic explanatory view of the configuration of an image display device according to an exemplary embodiment of the present invention;

FIG. 2 is a schematic view showing the configuration of a wavelength selection means;

FIG. 3 is a schematic view showing another configuration of a wavelength selection means;

FIG. 4A is a schematic view showing an example of the first wavelength range and second wavelength range;

FIG. 4B is a schematic view showing an example of the first wavelength range that is selected by the wavelength selection means, and

FIG. 4C is a schematic view showing an example of the second wavelength range that is selected by the wavelength selection means.

### REFERENCE SIGNS LIST

1 light source
2 wavelength selection means
3 optical integrator
4 relay lens system
5 lens
6 reflecting mirror
7 optical deflection means
8 separation/synthesis means
9 projection lens
10 screen
11 first reflection surface
12 second reflection surface
13 rotational axis
14 first wavelength range
15 second wavelength range
A incident region

### DESCRIPTION OF EMBODIMENTS

An exemplary embodiment of the present invention is next described with reference to the accompanying drawings.

The image display device according to the present invention is an image display device that forms and displays an image by light that is emitted from a light source, and is able to project a stereoscopic image such as a still image or a moving image.

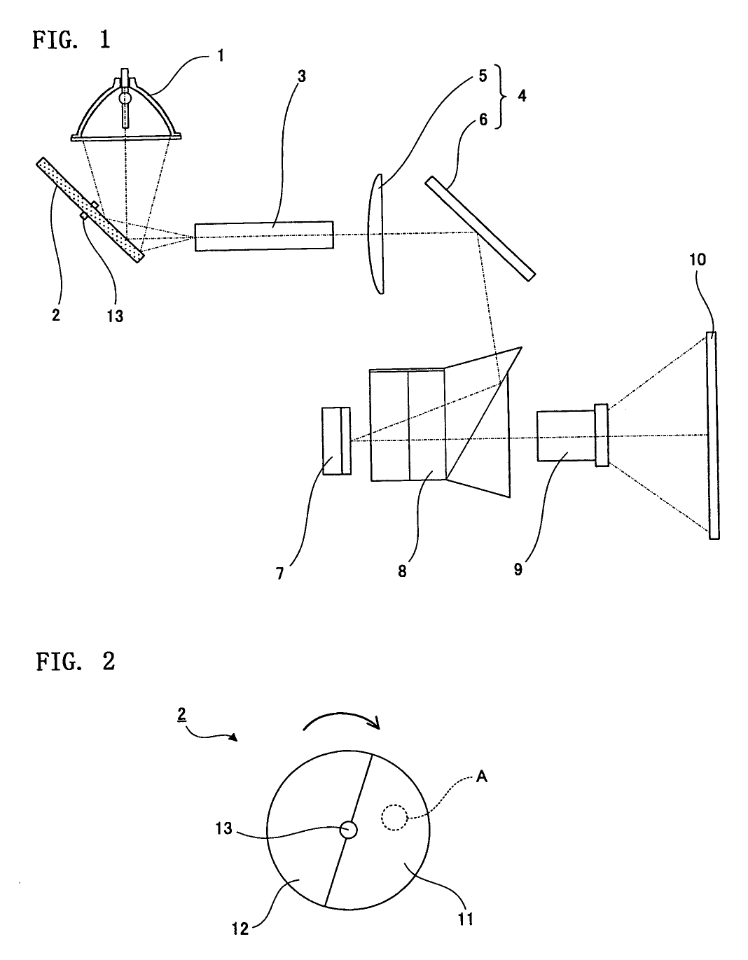

Referring to FIG. 1, the image display device of the present exemplary embodiment is provided with: light source 1, wavelength selection means 2, optical integrator 3, relay lens system 4, optical deflection means 7, and separation/synthesis means 8.

Light that is emitted from light source 1 is reflected by wavelength selection means 2, is transmitted by optical integrator 3, relay lens system 4 and separation/synthesis means 8 and irradiated into optical deflection means 7. Optical deflection means 7 deflects the light path of light emitted from the light source pixel by pixel to form an image to be projected onto screen 10. The light that has passed through optical deflection means 7 is transmitted by separation/synthesis means 8 and projection lens 9 and projected onto screen 10.

Wavelength selection means 2 is arranged on the light path of light emitted from the light source. Wavelength selection means 2 reflects, as reflected light, light belonging to a first wavelength range and light belonging to a second wavelength range that is different from the first wavelength range at a predetermined period.

An example of the actual configuration of wavelength selection means 2 is next described. FIG. 2 is a schematic view showing the configuration of wavelength selection means 2 in the present exemplary embodiment.

Wavelength selection means 2 has a round planar surface. A semicircular region on this planar surface is first reflection surface 11 that selectively reflects light belonging to the first wavelength range, and the remaining semicircular region is second reflection surface 12 that selectively reflects light belonging to the second wavelength range.

Wavelength selection means 2 has rotational axis 13 in the central portion of a disk and is configured to be rotatable around rotational axis 13. Light emitted from the light source is incident to the region (incident region A in FIG. 2) of one portion of wavelength selection means 2 that rotates at a predetermined period.

Essentially, wavelength selection means 2 alternately disposes first reflection surface 11 and second reflection surface 12 in the light path of light that is emitted from light source 1. In this way, wavelength selection means 2 alternately reflects light belonging to the first wavelength range and light belonging to the second wavelength range at a predetermined period.

Wavelength selection means 2 having this reflection characteristic can be fabricated by coating a dielectric multilayer film.

By arranging wavelength selection means 2 at a location at which the light path of light must be bent, wavelength selection means 2 of this configuration serves as a reflecting mirror for bending the light path of light that is emitted from light source 1. In this way, a superfluous reflecting mirror can be eliminated from the image display device, with the result that one optical component that transmits light can be eliminated compared to the image display device that is equipped with the transmissive wavelength-selective filter described in Patent Document 3.

Accordingly, the utilization efficiency of light of the image display device can be improved in proportion to the loss due to this transmission of light. As a result, the image display device can display a brighter image on screen 10. In addition, the elimination of an optical component reduces the fabrication cost of the image display device.

Wavelength selection means 2 preferably further includes the capability to transmit infrared rays. In this way, the heating of constituent elements of the image display device by infrared light that is included in the light emitted from light source 1 can be prevented, and increase in the temperature inside the device can be controlled.

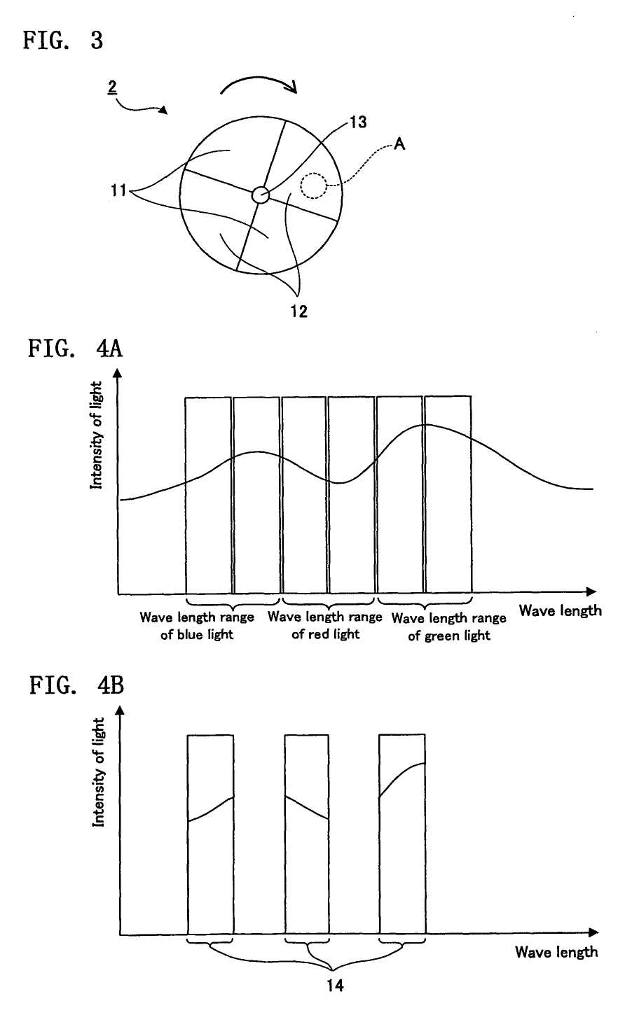

FIG. 3 is a schematic view showing another configuration of wavelength selection means 2. In FIG. 3, wavelength selection means 2 has a round planar surface. Wavelength selection means 2 further has rotational axis 13 in the central portion of a disk and is configured to be rotatable around rotational axis 13.

The planar surface of the disk is divided into four equal portions, the order of these portions with respect to the direction of rotation of the disk being: first reflection surface 11, second reflection surface 12, first reflection surface 11 and second reflection surface 12. Light emitted from light source 1 is incident to a region (incident region A in FIG. 3) that is a portion of wavelength selection means 2 that is rotating at a predetermined period.

When light belonging to the first wavelength range and the second wavelength range are reflected at the same period as the wavelength selection means shown in FIG. 2, the rotational speed of the wavelength selection means shown in FIG. 3 may be slower than the rotational speed of the wavelength selection means shown in FIG. 2.

In the present exemplary embodiment, light belonging to the first wavelength range is assumed to be light that is guided to the viewer's left eye, and light belonging to the second wavelength range is assumed to be light that is guided to the viewer's right eye. In order to guide light belonging to different wavelengths to the viewer's two eyes and cause the viewer to perceive a stereoscopic image, a filter that transmits the first wavelength range should be arranged in front of the left eye and a filter that transmits light of the second wavelength range should be arranged in front of the right eye.

To guide different images to the left and right eyes, the wavelength ranges of the light of each color that is contained in each of the first wavelength range and second wavelength range are preferably shifted so as not to overlap. The image display device is able to cause the viewer to perceive a stereoscopic image by setting a parallax between the image that is formed by light belonging to the first wavelength range (left-eye image) and the image that is formed by light belonging to the second wavelength range (right-eye image).

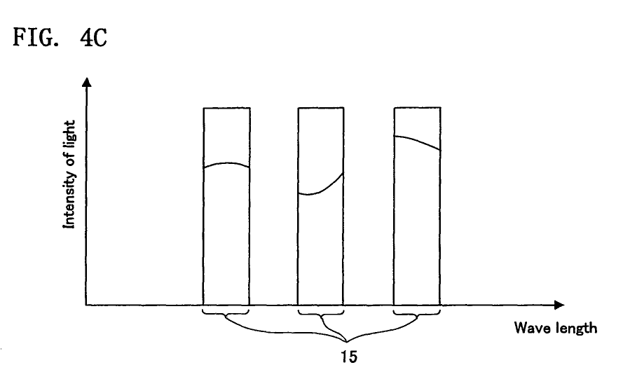

In the present exemplary embodiment, the first wavelength range and the second wavelength range are prescribed, as described hereinbelow, as one example. FIGS. 4A-4C are schematic views for explaining the first wavelength range and the second wavelength range. FIG. 4B is a schematic view showing the first wavelength range that is selected by the wavelength selection means, and FIG. 4C is a schematic view showing the second wavelength range.

As shown in FIG. 4A, the wavelength range of red light, the wavelength range of blue light and the wavelength range of green light are each divided into two wavelength ranges.

In the present specification, red light refers to light of a single wavelength that is perceived as red light in optics. Similarly, blue light and green light refer to the light that is perceived as blue light and green light, respectively, in optics.

As shown in FIG. 4B, one of the two wavelength ranges into which the light of each color is divided belongs to first wavelength range 14. Further, as shown in FIG. 4C, the other of the two wavelength ranges into which the light of each color is divided belongs to second wavelength range 15.

In this way, first and second wavelength ranges 14 and 15 include wavelength ranges of the light of each of the colors that are perceived as red light, blue light and green light. As a result, images corresponding to full color can be displayed on screen 10.

In order to cause a viewer to perceive a stereoscopic image, a left-eye image and a right-eye image must be alternately displayed at a predetermined period on screen 10. If wavelength selection means 2 described hereinabove is used, light belonging to the first wavelength range and light belonging to the second wavelength range can be generated at a predetermined period on the light path from light source 1 up to projection lens 9 of FIG. 1.

Accordingly, the rotation rate of wavelength selection means 2 is determined to correspond to the period of the display of the left-eye image and right-eye image.

First and second wavelength ranges 14 and 15 may be the aggregate of a plurality of divided wavelength ranges as in the example described above. Alternatively, first wavelength range 14 and second wavelength range 15 are not limited to the above example and may be any combination of wavelength ranges.

Optical integrator 3 is provided for equalizing the light quantity distribution of light that is transmitted through optical integrator 13. Optical integrator 3 is installed if it is needed. A rod integrator that is formed in a rod shape can be used as optical integrator 3.

Optical integrator 3 may be arranged at any location as long as it is on the light path of light that is emitted from light source 1 and between light source 1 and optical deflection means 7.

Relay lens system 4 are provided for guiding light that has passed through optical integrator 3 to optical deflection means 7 by way of separation/synthesis means 8. Relay lens system 4 may be a single lens or may be made up from a plurality of lenses. Relay lens system 4 are installed if it is necessary.

In the present exemplary embodiment, relay lens system include lens 5 for changing light, that has passed through optical integrator 3, into a parallel beam and reflecting mirror 6 for guiding the light to separation/synthesis means 8.

Separation/synthesis means 8 is installed when configuring an image display device for color display. Separation/synthesis means 8 separates light paths of light that is irradiated into optical deflection means 7 for each wavelength range. Because the light paths of light belonging to different wavelength ranges are thus separated, optical deflection means 7 is able to deflect the direction of light for each different wavelength range.

Optical deflection means 7 includes a plurality of deflection elements that can deflect the direction of the advance of light. The deflection of the direction of the advance of light by a plurality of independent deflection elements enables the formation of a desired image.

The ON state and OFF state of the deflection elements can be controlled. A deflection element in the ON state deflects light in the direction of the disposition of projection lens 9 for projecting light. A deflection element in the OFF state deflects light in a direction in which projection lens 9 is not disposed.

In the present exemplary embodiment, the deflection elements are reflecting surfaces that reflect light, and optical deflection means 7 is able to independently deflect the direction of light that is irradiated to each reflecting surface.

Each reflecting surface is digitally controlled and is configured to enable switching between the ON state and OFF state. Switching between the ON state and OFF state can be realized by controlling the angle of the reflecting surface.

Controlling the time of the ON state of each deflection element enables adjustment of the intensity of light that is transmitted by the deflection element. A digital micromirror device (DMD) that is capable of controlling light at low power and high speed is ideal such as optical deflection means 7 described hereinabove. Alternatively, a transmissive liquid crystal panel may be used as an image formation means in place of optical deflection means 7 such as a DMD.

Light that has been transmitted by a deflection element in the ON state is again irradiated into separation/synthesis means 8. Separation/synthesis means 8 synthesizes the three types of light (red light, blue light and green light) that correspond to the same pixel, whereby the image display device is able to display a full-color image.

Light that passes through separation/synthesis means 8 is projected onto screen 10 by way of projection lens 9. A prism such as a Philips prism or a dichroic prism can be used as the above-described separation/synthesis means. In this way, the image display device is able to display a stereoscopic image.

Wavelength selection means 2 according to the above-described exemplary embodiment is preferably configured to enable the exchange of reflecting mirrors that reflect visible light. In this way, the image display device is able to project not only a stereoscopic image but a normal two-dimensional image as well.

The dispositions of each of the constituent elements of the image display device according to the present invention may be exchanged where it is possible for such exchanges to take place. For example, wavelength selection means 2 may be installed at the location of reflecting mirror 6 that is included in relay lens system 4. Alternatively, wavelength selection means 2 may be arranged between optical deflection means 7 and projection lens 9.

The present exemplary embodiment enables a reduction of the number of reflecting mirrors by the installation of wavelength selection means 2 at a location at which the light path of light emitted from light source 1 must be bent. As a result, the loss of light is reduced and the utilization efficiency of light is improved.

The image display device of the present invention is not limited to the above-described configuration. The present invention may be suitably employed in a device of any configuration that is an image display device having means that selectively uses specific wavelengths.

The image display method of the present invention is suitably implemented by using the image display device of the above-described exemplary embodiment. The image display method according to one exemplary embodiment of the present invention, as has been made clear by the preceding description, forms an image by light that is emitted from a light source for display on a screen.

The image display method of the present invention includes steps of emitting light from a light source and then reflecting light belonging to a first wavelength range and light belonging to a second wavelength range that is different from the first wavelength range as reflected light at a predetermined period.

In addition, when light that has been emitted from a light source is reflected, the ultraviolet light that is included in the light may be transmitted.

Although a preferable exemplary embodiment of the present invention has been shown and described in detail, it should be understood that the present invention is open to various modifications and amendments that do not depart from the scope or the gist of the scope of the appended claims.

1. An image display device that forms and displays an image from light emitted from a light source, comprising:
wavelength selection means that is arranged on a light path of light emitted from the light source and that, as reflected light of this light, reflects light belonging to a first wavelength range and light belonging to a second wavelength range that differs from said first wavelength range at a predetermined period.

2. The image display device as set forth in claim 1, wherein said wavelength selection means also serves as a reflecting mirror that bends the light path of light that is emitted from said light source.

3. The image display device as set forth in claim 1, wherein:
said wavelength selection means includes a first reflecting surface that reflects light belonging to said first wavelength range and a second reflecting surface that reflects light belonging to said second wavelength range; and
said wavelength selection means is provided with said first reflecting surface and said second reflecting surface installed to allow alternate disposition on the light path of light emitted from said light source.

4. The image display device as set forth in claim 3, wherein:
said first reflecting surface and said second reflecting surface are each divided into a plurality of reflecting surfaces; and
the divided surfaces of said first reflecting surface and the divided surfaces of said second reflecting surface are each installed to allow alternate disposition on the light path of light emitted from said light source.

5. The image display device as set forth in claim 1, wherein said wavelength selection means has the capability of transmitting infrared light that is contained in the light emitted from said light source.

6. The image display device as set forth in claim 1, wherein said wavelength selection means is configured to allow exchange of reflecting mirrors that reflect visible light.

7. The image display device as set forth in claim 1, further comprising optical deflection means comprising means that forms an image by light emitted from said light source and that deflects the direction of light reflected by said wavelength selection means.

8. The image display device as set forth in claim 7, wherein said optical deflection means comprises a digital micromirror device.

9. The image display device as set forth in claim 7, further comprising separation/synthesis means that separates the light path of light irradiated into said optical deflection means into light paths of light belonging to each wavelength range, and further, that synthesizes the light paths of light belonging to each wavelength range that has passed through said optical deflection means.

10. The image display device as set forth in claim 9, wherein said separation/synthesis means comprises a Philips prism or a dichroic prism.

11. The image display device as set forth in claim 7, further comprising an optical integrator that is on the light path of light emitted from said light source and that equalizes the light quantity distribution of light between said light source and said optical deflection means.

12. The image display device as set forth in claim 1, wherein said image display device displays a stereoscopic image by displaying an image formed by light belonging to said first wavelength range and light belonging to said second wavelength range at said predetermined period.

13. The image display device as set forth in claim 1, wherein:
wavelength ranges of each of the colors of light perceived as red light, blue light and green light in optics are included in said first wavelength range;
wavelength ranges of each of the colors of light perceived as red light, blue light and green light in optics are included in said second wavelength range; and
each of the wavelength ranges of light colors contained in said first wavelength range and said second wavelength range is shifted so as not to overlap.

14. An image display method that forms and displays an image by light emitted from a light source, wherein said image display method comprises:
emitting light from said light source; and
reflecting light belonging to a first wavelength range and light belonging to a second wavelength range that differs from said first wavelength range as reflected light at a predetermined period.

15. The image display method as set forth in claim 14, wherein, when reflecting light emitted from said light source in said emitting and said reflecting, ultraviolet light contained in the light is transmitted.

16. The image display method as set forth in claim 14, wherein said image display method displays a stereoscopic image by displaying an image formed by light belonging to said first wavelength range and light belonging to said second wavelength range at said predetermined period.

17. The image display device as set forth in claim 2, wherein:
said wavelength selection means includes a first reflecting surface that reflects light belonging to said first wavelength range and a second reflecting surface that reflects light belonging to said second wavelength range; and
said wavelength selection means is provided with said first reflecting surface and said second reflecting surface installed to allow alternate disposition on the light path of light emitted from said light source.

18. The image display device as set forth in claim 2, wherein said wavelength selection means transmits infrared light that is contained in the light emitted from said light source.

19. The image display device as set forth in claim 3, wherein said wavelength selection means transmits infrared light that is contained in the light emitted from said light source.

20. The image display device as set forth in claim 4, wherein said wavelength selection means transmits infrared light that is contained in the light emitted from said light source.
